(19) United States
(12) Patent Application Publication
(10) Pub. No.: US 2004/0132519 A1
(43) Pub. Date: Jul. 8, 2004

(54) Additional wagering provisions for blackjack

(76) Inventor: Kelly E. Holm, Spokane, WA (US)

Correspondence Address: Richard C. Litman, LITMAN LAW OFFICES, LTD., P.O. Box 15035, Arlington, VA, 22215, US

(21) Appl. No.: 10/737,761

(22) Filed: Dec. 18, 2003

Related U.S. Application Data
(60) Provisional application No. 60/436,665, filed on Dec. 30, 2002.

(51) Int. Cl. A63F 13/00; A63F 9/24

(52) U.S. Cl. 463/13

(57) ABSTRACT

A series of additional wagering provisions for the game of blackjack (twenty-one), allows participating players to place supplemental wagers independently of conventional play of the blackjack hand. The present wagering provisions are based upon a composite hand formed by the first two face up cards dealt to the participating player, and the first face up card to the dealer. The participating player wins the supplemental wager if the three card composite hand has a total count of twenty-one and comprises two ten count cards and an ace, or a sequence comprising a six, seven, and eight. Additional payouts are provided when the all cards forming the composite hand are identically suited, with a jackpot payout provided when the participating player draws a third card for his or her suited six-seven-eight blackjack hand, and that card matches the rank and suit of the dealer's card of the composite hand.

### CROSS-REFERENCE TO RELATED APPLICATION

This application claims the benefit of U.S. Provisional Patent Application Serial No. 60/436,665, filed Dec. 30, 2002.

### BACKGROUND OF THE INVENTION

1. Field of the Invention

The present invention relates generally to wagering games using playing cards, and more specifically to additional wagering provisions for the card game of blackjack, or twenty-one. The present invention includes the various wagering provisions of the conventional game of blackjack, but also includes additional wagers and payouts for various combinations of the cards dealt face up to the player and dealer, during each hand. In effect, the present additional blackjack wagering provisions enable the bettor to place wagers simultaneously upon a second hand during play of a conventional blackjack hand, with the second-hand comprising only the first three (or for jackpot wagers, a fourth) face up cards dealt to the player and dealer at the beginning of each hand.

2. Description of Related Art

The wagering card game of blackjack, or twenty-one, is quite popular with many people due to its relative simplicity and the fact that a knowledgeable player may have a slight advantage or “edge” during the game. The basic game is played with a single dealer and one or more players, with the object of each player being to gain a total card count which exceeds the dealer=s count, without going over twenty-one (“busting”). Many variations of the game are known, depending upon whether the cards are dealt face up or face down, the point at which the dealer may be required to draw an additional card, and additional or side wagers such as “doubling down,” “insurance bets,” and “splitting pairs.”

The present additional wagering provisions for blackjack are used with the variation of the game in which all cards are dealt face up. This variation of the game is played widely in many casinos and areas of the U.S., as well as in other areas of the world where blackjack is played. The dealing of all cards face up, permits players to consider possible combinations of cards between their own hands and the dealer=s hand, which combinations are not possible in other games where the dealer=s cards are concealed from the players. Yet, until the development of the present wagering provisions, no such additional wagering provisions had been developed for “face-up” blackjack play, even though such play opens the door for potential additional wagers and the expansion of the game.

Accordingly, the present invention provides a series of additional wagers which may be placed upon combinations of an individual player=s hand and the dealer=s hand in the game of blackjack, where that game is played with all card values and denominations being visible to all players during play, i.e., the cards are dealt face up. The present wagering provisions allow each player to place additional wagers on the probability of the initial two cards dealt to the player and the initial single dealer card forming a composite hand equaling a count of twenty-one. Additional payouts are provided for players making such an additional wager, when the combined dealer and player cards forming the composite hand comprise two ten count cards (i.e., ten through king) and an ace, or a six-seven-eight sequence, with an even higher payout provided when the three cards of the composite hand are all of the same suit. In addition, the present wagering provisions also provide an additional “jackpot” payout if the player elects to take a third card to fill out the two cards he or she holds in his or her blackjack hand, when those two cards comprise two of the three six-seven-eight identically suited cards forming the composite hand, and that third card of the player's blackjack hand matches the single face up card of the dealer=s hand to that point.

The present invention also includes a playing table layout or “felt,” which may be used with the present game. The table layout includes an additional position for each player, for the additional wagers which may be placed in accordance with the present game. The present game may be played using the table layout or “felt” disclosed herein, or may be played using a conventional blackjack table layout, if so desired.

A discussion of the related art of which the present inventor is aware, and its differences and distinctions from the present invention, is provided below.

U.S. Pat. No. 5,377,993 issued on Jan. 3, 1995 to Ronald H. Josephs, titled “Wagering Game,” describes a modified twenty-one (blackjack) game, with provision for additional wagers thereon. The various additional wagers of Josephs make use of only two cards dealt to the player, and two cards dealt to the dealer, or a total of four cards. The four cards are considered in combination as they may form any of a number of abbreviated poker hands, i.e., straight, flush, straight flush, four of a kind, etc. However, while Josephs states that his additional wagering system is based upon a conventional twenty-one or blackjack game, this is not actually so. According to col. 3, line 67 through col. 2, line 5 of the Josephs disclosure, the player is limited to only two cards, rather than being allowed to take an additional card(s) if he or she so chooses, as in conventional blackjack as played with the present additional wagering provisions. Josephs states that this limits the chances of the player to achieve a count of twenty one with his or her cards, but that the additional wagers provided, compensate for this potential loss by providing additional opportunities for the player to win.

In contrast, the present additional wagering provisions use the rules of the conventional game of blackjack or twenty-one, with the player being allowed to take additional cards over the first two dealt, as desired. However, only the first two cards dealt to the player, and the first card dealt to the dealer, are considered in combination to make a three card additional composite wagering hand for the player, with the exception of a third player card for a potential jackpot payout. Another distinction between the Josephs game and the present wagering systems, is that Josephs requires the player to win the blackjack hand, i.e., to have a two card count higher than the dealer's two or more cards without exceeding twenty-one, before the player is allowed to consider any combinations of player and dealer cards for further wagers. In other words, even if the two player cards and the first two dealer cards comprise a winning poker type hand for the player, the player will not be paid for such a wager if the player's blackjack hand loses to the dealer's.

Josephs states in the first paragraph of his Description of the Preferred Embodiments, that his game is a modified version of twenty-one which reduces the player's chances of winning. He also states there that the player is provided with the option of placing additional wagers on combinations of two player and two dealer cards, as compensation. However, this cannot actually compensate for the reduced probability of a player win, when any blackjack hand loss by the player, precludes the player from winning any additional wagers on other card combinations.

U.S. Pat. No. 5,707,285 issued on Jan. 13, 1998 to Vaughn Place et al., titled “Method And Apparatus For Random Prize Selection In Wagering Games,” describes additional wagers which may be placed upon card games to provide larger prizes than is the norm in such games. Payouts in games of blackjack and the like, are generally relatively small in comparison to many electronically interlinked slot machines and the like, where a multitude of bets can be pooled across a large number of machines and where the odds of winning a large payout is generally very small. Place et al. provide for additional side bets to be placed upon the outcome of the play of a card hand in a game, with their system providing for the random selection of a prize for the bettor if he or she wins the wager. However, Place et al. do not provide for any wagers based upon any combination of cards held by the player and dealer. Also, while Place et al. disclose a playing table or surface including a side wager area for each playing position for their game, the side wager areas are physically separated from their corresponding playing positions, and are not positively connected thereto, as in the playing surface of the present wagering system.

U.S. Pat. No. 5,743,532 issued on Apr. 28, 1998 to William M. Lafferty, titled “Method Of Making A Side Bet During Blackjack,” describes a conventional blackjack game which includes a potential side bet by the player, based upon the player=s perception of the likelihood of certain card combinations in the dealer=s hand. The player wins the side bet if the dealer=s first card has a value of ten and his second card is an ace, for a total of twenty-one in the dealer=s hand. Other values result in a losing side bet for the player. This system is essentially a variation of the conventional “insurance bet,” where the player is allowed to place an insurance bet if the dealer=s first card is an ace. In any event, no wagers on combinations of the player=s and dealer=s cards is provided, and the playing surface disclosed does not include any supplemental wagering positions, as provided by the present wagering provisions.

U.S. Pat. No. 5,791,989 issued on Aug. 11, 1998 to J. F. R. Slinkman, titled “Method Of Playing A Blackjack Game With A Modified Betting Arrangement,” describes an optional secondary or side bet which may be placed by the player before the hand is dealt. The secondary bet is that the dealer will deal himself or herself a “standing” hand, i.e., that the count of the two dealer cards will be sufficiently high that the dealer will not be allowed to take another card, under the house rules. (This is almost universally a two card count of seventeen, with some variation depending upon whether the count is “hard,” i.e., with no ace, or “soft,” i.e., with the variability provided by the one or eleven value of an ace.) This wager is only based upon the dealer=s hand, and does not take into account any of the player=s cards, or combination of the player=s and dealer=s cards, as do the present additional wagering provisions. Moreover, the playing table or surface disclosed by Slinkman does not contain any positions for supplemental wagers. Only two separated positions are provided for each player, for card placement and placement of a primary wager.

U.S. Pat. No. 5,836,586 issued on Nov. 17, 1998 to Howard M. Marks et al., titled “Method Of Playing A Modified Twenty-One Card Game,” describes additional side wagers which may be made by the player upon the outcome of the dealer hand during play. The Marks et al. wagers are that the dealer hand will total a specific count from seventeen through twenty-one, or bust, i.e., exceed twenty-one. The Marks et al. wagering system thus builds upon the Slinkman system, discussed immediately above. As in the Slinkman system, the Marks et al. system does not consider any of the player=s cards in combination with the dealer=s cards. No supplemental player wagering positions are disclosed for the Marks et al. playing surface layout.

U.S. Pat. No. 6,113,102 issued on Sep. 5, 2000 to Howard M. Marks et al., titled “Modified Black Jack Card Game (SIDE BET 21),” is a continuation in part of the >586 U.S. patent issued to the same patentees, and discussed immediately above. The same points raised in the discussion of the Marks et al. >586 U.S. patent, i.e., the lack of any combination of the player=s and dealer=s cards in determining the supplementary wagers and differences in the game table or surface, apply here as well.

U.S. Pat. No. 6,146,270 issued on Nov. 14, 2000 to Marcel Huard et al., titled “Auxiliary Game With Random Prize Generation,” describes a secondary lottery type game, which is independent of the primary game, be it blackjack or any other card or non-card gambling game. Huard et al. simply use a single card (or other selection means) held by a player to determine the player receiving the supplemental prize, and provide that player with a randomly selected prize or reward. The Huard system does not consider any card combinations of the player=s and/or dealer=s hands, either separately or additively with one another.

U.S. Pat. No. 6,158,741 issued on Dec. 12, 2000 to David C. Koelling, titled “Method Of Playing Blackjack With A Side Wager,” describes a side wager for blackjack, in which the player bets on the likelihood of various card combinations of the dealer's and player's hands. The lowest paying wagers comprise any total of twenty points in the player=s hand, in combination with the dealer's face up card having a value of ten. Koelling provides for higher payouts for flush player hands, i.e., where all cards are of the same suit, and where player hands are of the same rank, i.e., two kings, queens, jacks, or tens. Koelling also provides for even higher payouts when the dealer's face up card matches the rank and/or suit of correspondingly matched player cards, and a jackpot payout when the dealer=s second card also matches in rank and suit. However, Koelling fails to provide the additional possibilities of the present wagering provisions, i.e., straights, where a combination of the dealer=s and player=s cards are in numerically or ranking sequential order, particularly where those cards have a total count of twenty-one.

As the game of blackjack is based upon the goal of achieving a card count as close as possible to twenty-one, the present additional wagering provisions are considerably more logical in the context of the game, than are the Koelling wagers. Moreover, the present wagering provisions do not consider identically ranked cards, i.e., pairs, three of a kind, etc., as does Koelling. This simplifies the present wagering provisions, and allows a faster paced game than would be permitted with all the possibilities of Koelling. The present additional wagering provisions are adapted for casino play using multiple decks of cards. However, the present wagers (with the exception of the provision for the player turning up a third card identical to the dealer=s face up card, for a jackpot payout) may be played using only a single deck, whereas Koelling requires multiple card decks at all times, due to his provision for identically matching cards in the dealer's and player's hands at all stages of his wagers.

U.S. Pat. No. 6,179,710 issued on Jan. 30, 2001 to Thomas E. Sawyer et al., titled “Electronic System And Method For Operating An Auxiliary Incentive Game,” describes an auxiliary payout system (not actually a game, as players are not required to do more than enter play of the primary game, in order to participate) which awards bonus points and/or prizes to players for sufficient playing time or participation in the primary game. Sawyer et al. state that their system is primarily intended for use with a game known as “Ten Stix 21™,” which is closely related to conventional blackjack or twenty-one. However, the Sawyer et al. system does not rely upon any specific outcome in the game itself, and may be played with any card or non-card gambling game. Moreover, no supplemental wagering positions are provided on the Sawyer et al. playing surface. The Sawyer et al. system thus more closely resembles the system disclosed in the >800 U.S. patent to Huard et al., discussed further above, than it does the present wagering provisions.

U.S. Pat. No. 6,293,551 issued on Sep. 25, 2001 to Derek J. Webb, titled “Blackjack Card Game Incorporating Two-Card 21 Wagers,” describes an expanded side or “insurance” bet which may be placed whenever the dealer=s first card is either an ace or a ten value card. Other options and payouts are also provided, depending upon whether or not the player=s first card is an ace or ten value card, whether or not the two player cards are of the same suit or color, or whether or not the ten value card is of a predetermined specific suit. The Webb wagering system is more closely related to that of the Lafferty >532 U.S. patent, discussed further above, than it is to the present wagering provisions. The only player wagering positions disclosed on the playing surface of the Webb disclosure are for primary wagers, with no provision for supplemental wagers being shown in the Webb playing layout.

U.S. Pat. No. 6,416,406 issued on Jul. 9, 2002 to Gerald Duhamel, titled “Method For Playing An Auxiliary Game With Prize Rewarding System,” essentially describes the provision of bonus payouts for card hands which meet certain criteria beyond merely winning the hand. Duhamel cites a blackjack example, in which a winning player hand which totals less than twenty-one points, does not win the auxiliary game, but which totals exactly twenty-one points, wins the auxiliary game. Duhamel also makes similar provisions for poker, in which higher ranking hands (e.g., three of a kind, flushes, straights, etc.) are rewarded according to his auxiliary game, but lower ranking (but still winning) hands, e.g. pairs, are not. Duhamel does not provide for any combination of the player and dealer cards in blackjack, in his auxiliary game.

U.S. Patent Publication No. 2002/45,471 published on Apr. 18, 2002, titled “Bet The House Blackjack,” describes a series of supplementary blackjack wagers, based upon possibilities in the dealer hand only. The supplemental wagers are based upon the possibilities of the dealer hand comprising from two to seven cards, and/or an even or odd point count, and/or all cards being one color (red or black). The dealer hand cannot exceed twenty-one in this wagering system. The supplementary wagers do not include any combining of the player's cards with the dealer's cards, as is done in the present additional blackjack wagering provisions. While the playing surface discloses both blackjack and supplemental (“Bet The House”) wagering positions for each player, the primary blackjack wagering positions are much smaller than the supplemental positions, which is opposite the player position configurations of the present playing surface layout, and are not positively connected thereto.

Finally, European Patent Publication No. 338,644 published on Oct. 25, 1989, titled “Apparatus For Progressive Jackpot Gaming,” describes an additional wagering system which may be used with blackjack or other wagering card games. The system awards winning card hands which also comprise a series of specific predetermined cards, using a progressive jackpot system. However, the wagering system does not consider the addition of the dealer cards in combination with the player hand, as is done in the present additional wagering provisions. The playing surface discloses a playing position for each player, but the unconnected adjacent area for each playing position is not described.

None of the above inventions and patents, either singly or in combination, is seen to describe the instant invention as claimed.

### SUMMARY OF THE INVENTION

The present invention comprises various embodiments of additional wagering provisions which may be used in the game of blackjack or twenty-one, and includes a gaming table layout or playing surface configured to accommodate the wagering provisions of the present invention as well. The wagering provisions of the present invention may be incorporated into a conventional game of blackjack, and operate independently of the game. Players may elect to participate in the present wagering system by placing an optional supplemental wager, if so desired, or may elect not to participate in the additional wagers of the present invention, as desired. If the players do not elect to participate, i.e., place an additional wager, then their play of the blackjack game continues conventionally in accordance with well known rules. The rules for Blackjack and certain variations thereon are described in various sources, e.g., Scarne's New Complete Guide to Gambling, by John Scarne (Harper & Row, New York, 1973), and Hoyle's Modern Encyclopedia of Card Games (Doubleday & Co., New York, 1990).

The present additional blackjack wagers are based upon a combination of three cards, comprising the first two cards dealt face up to the participating player, and the first card dealt face up to the dealer. These three cards are considered to form a composite hand for each participating player, with each participating player using the same initial card dealt to the dealer to complete the three card composite hand.

Play of the present additional wagering system is initiated voluntarily by each player in the blackjack game, when a player elects to place a supplemental wager before the cards are dealt. A supplemental wager position is provided adjoining each player position on the playing surface or table. The supplementary wager is based upon one or more of a series of possible outcomes in the three card composite hand. The first winning possibility for the participating player is that the three cards of the composite hand comprise two ten count cards (i.e., tens, jacks, queens, or kings) and an ace. Such a composite hand would have a total count of twenty-one. However, it should be noted that the composite hand is not used to determine whether or not the player's hand beats the dealer's hand in the actual game of blackjack or twenty-one. The actual two (or more) cards dealt to the player are used for this determination.

Another possible winning combination for the composite hand is that the three cards comprise a sequence of six, seven, and eight value or count cards, having a total count of twenty-one. Again, the point count or total of the composite hand is not used by the player for comparison against the dealer's hand, but rather is an independent hand upon which an independent wager may be placed. An even higher payout to the participating player may be made if the cards of the composite hand comprise two ten count cards and an ace or a six-seven-eight sequence of twenty-one points and are also flush, i.e., all of the same suit.

It will be noted that where such a straight or straight flush composite hand has been dealt, that the highest possible point count for the two cards of the player's hand will be fifteen points, if the player holds the seven and eight of the six-seven-eight composite hand. The player may wish to draw or to be dealt a third card, under these circumstances. The present additional wagering system recognizes this possibility, and awards a jackpot payout to the player, in the event that the third card dealt to the player matches the rank and suit of the single face up dealer card. Obviously, this possibility of a jackpot payout exists only when two or more decks of cards are used in the game, as is conventional in casino play.

In accordance with the present invention, at least a portion of the revenue earned by the present additional wagering systems may be used for charitable contributions, if so desired. The present additional wagering provisions includes a playing surface or “felt” configured to provide notification of such a charitable cause, which may encourage players to participate by placing additional supplemental wagers on composite player—dealer hands in accordance with the present invention.

Accordingly, it is a principal object of the invention to provide additional wagering provisions in an otherwise conventional blackjack game, wherein two of the cards dealt to the participating player and a first dealer card are considered as a three card composite hand.

It is another object of the invention to provide payouts to participating players for composite hands having a point count of twenty-one, wherein the three cards comprise either two ten count cards and an ace, or a six-seven-eight sequence.

It is a further object of the invention to provide higher payouts to participating players for composite hands comprising two ten count cards and an ace or a six-seven-eight sequence in which all cards are identically suited, and jackpot payouts wherein the participating player draws a third card which matches the rank and suit of the single dealer card of the composite hand.

Still another object of the invention is to provide a series of additional wagering provisions for blackjack, in which at least a portion of the revenue earned by the additional wagering provisions is provided to a charitable cause, with notification of such charitable donation being provided on the playing surface of the game.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a top plan view of the playing surface used for playing blackjack and for placing additional wagers according to the present invention.

FIG. 2A is a first portion of a flow chart disclosing the basic elements of the present additional wagering provisions.

FIG. 2B is a second portion of the flow chart, joining the chart of FIG. 2A at points 2B1 through 2B4.

Similar reference characters denote corresponding features consistently throughout the attached drawings.

### DETAILED DESCRIPTION OF THE PREFERRED EMBODIMENTS

The present invention comprises various embodiments of additional wagering provisions which may be incorporated with the conventional game of blackjack, or twenty one. The present additional wagering provisions are independent of the blackjack game, with the blackjack game being played conventionally whether or not the present wagering provisions are incorporated. Where provided, the present additional wagering provisions are completely voluntary on the part of the players, and may be entered into as desired by any player before any given hand is dealt. Any win or loss according to the present additional wagering provisions, is completely independent of the win or loss of the conventional blackjack hand being played.

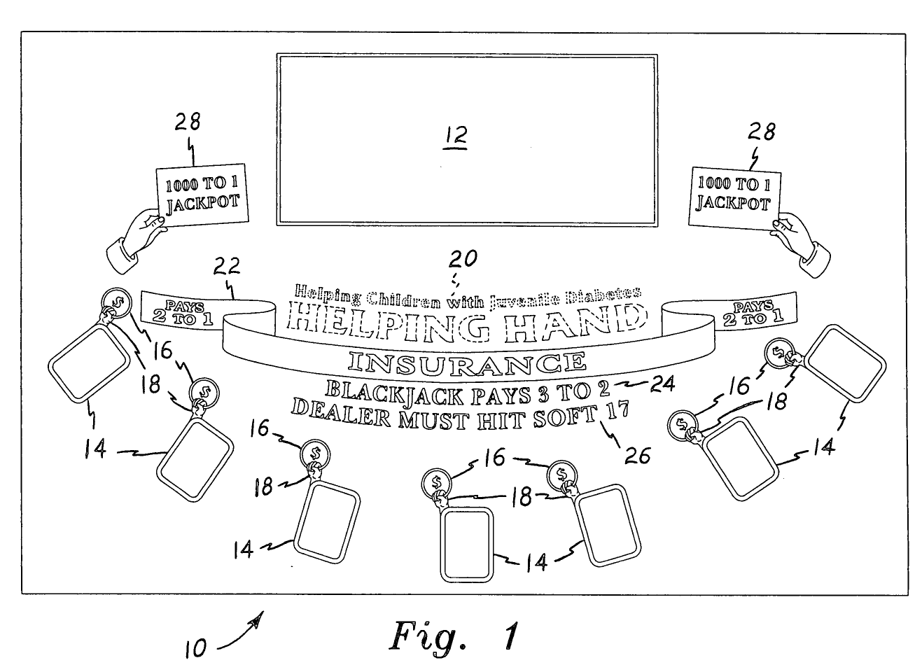

FIG. 1 illustrates a gaming table layout or playing surface 10 for the present wagering provisions. In a preferred embodiment, the present wagering provisions are employed in a casino game, with the table layout 10 having a napped or felt surface, as is conventional in such playing surfaces for card games. The table “felt” 10 is replaceable, as needed, for wear and tear due to the heavy use seen during casino play. The playing surface 10 includes a single dealer position 12 and a plurality (e.g., seven) of individual player positions or card placement areas 14. Each of the card placement areas 14 provides for the placement of a wager by, and the dealing of two or more cards to, the corresponding player positioned at each of the areas 14, in accordance with the conventional rules for playing the card game of blackjack.

Each card placement area 14 also has a supplemental wagering position 16 extending therefrom, and positively and directly connected thereto in some manner. In the exemplary playing surface layout 10 of FIG. 1, a symbolic hand 18 extends from each of the primary player or wager positions 14, to join each primary position 14 with the corresponding supplemental wagering position 16. This is in keeping with the “helping hand” theme of the present supplemental or additional wagering provisions, in which it is preferred that at least a portion of any income earned by the holder of the rights to the present game be donated to a charitable cause. This may be noted to players by appropriate notification 20 on the playing surface 10, e.g., “Helping children with juvenile diabetes,” or other cause, as desired.

The playing surface layout 10 also preferably includes other information thereon, e.g., notification 22 of the availability of “insurance” wagers by players in the event an ace is dealt for the first card of the dealer hand, notification 24 of the payout odds for a player getting “blackjack” or a count of precisely twenty-one, and notification 26 of the dealer hand count where the dealer must draw another card or stand with the cards already dealt. These notifications 22 through 26 are conventional in the game of blackjack, and are generally displayed on all blackjack playing surfaces, with perhaps some slight variation between different casinos or areas for the draw or stand dealer hand count notice 26.

The playing surface 10 used with the present additional wagering provisions also includes other notification 28 thereon, advising players of the odds for a jackpot payout, explained further below. The jackpot payout provision is a result of one of the additional wagers which may be placed on the game of blackjack, in accordance with the present invention. This payout, as well as others, is explained in detail further below.

The game is played using one or more decks (conventionally, several decks are used simultaneously) of conventional playing cards, with each deck having fifty-two cards of four suits having thirteen cards each, from the face cards (king, queen, and jack) through the spot cards consisting of the ten through ace. All of the cards have identical back surfaces, with the face surfaces containing the suit and rank indicators noted above. These cards are well known and conventional, and universally used in blackjack.

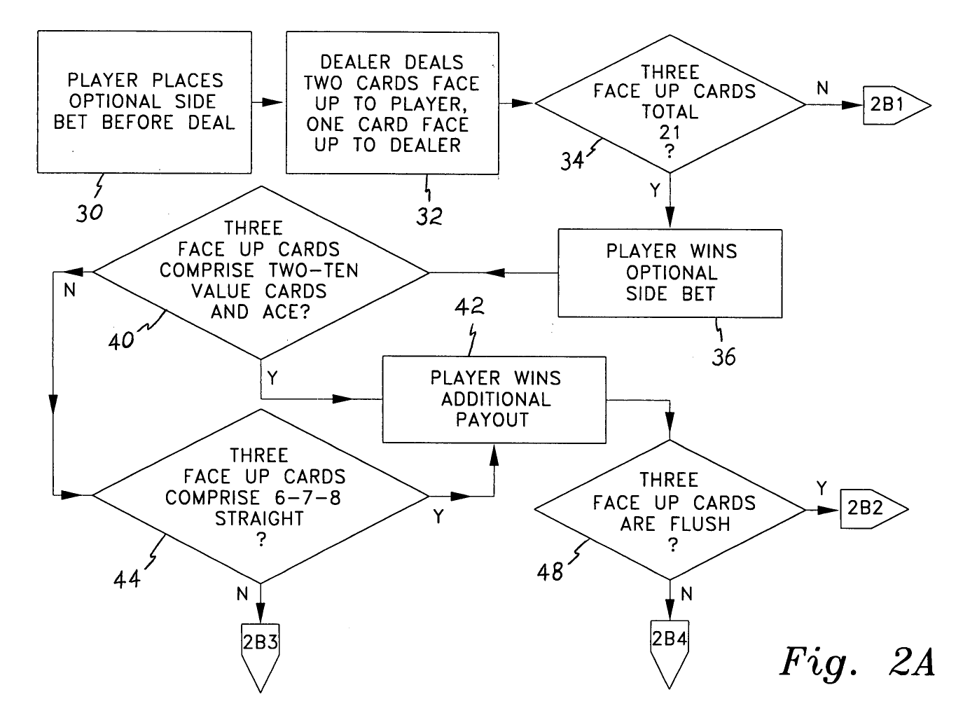

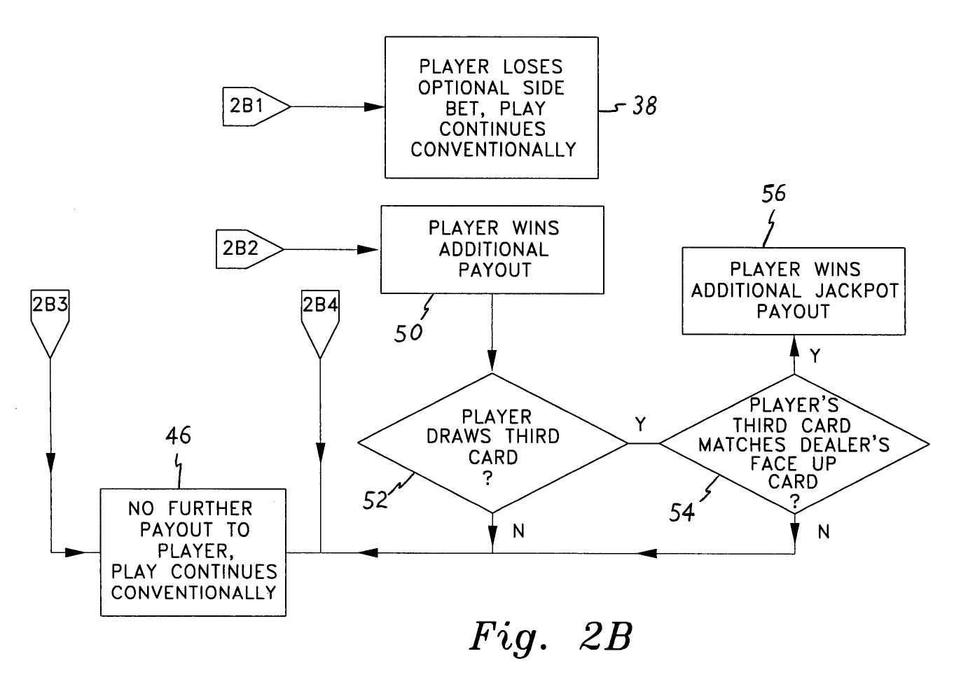

FIGS. 2A and 2B disclose the basic steps in the method of wagering according to the present additional wagering provisions, and the outcomes necessary to win or lose such additional wagers. Initially, a player or players of the blackjack game determine whether or not they wish to participate in the additional wagering provisions provided in accordance with the present invention. The present additional wagering system is completely voluntary, and those players who do not wish to participate may continue to play blackjack conventionally according to its well known rules. The present additional wagers do not change the method of play of blackjack in any way, but rather add the ability to place additional wagers on additional card combinations not previously considered during play.

A player(s) wishing to participate in the present additional wagering provisions places an optional side wager in the appropriate supplemental wager position 16 of the playing surface 10 illustrated in FIG. 1 before any cards are dealt, as indicated by the first step 30 of FIG. 2A. Other conventional wagers are also placed by players on their own hands before the cards are dealt, in accordance with conventional rules of play. The wagering of players on their own blackjack hands before the cards are dealt is mandatory in casino and other gambling play of the game. However, supplemental wagers placed in accordance with the present additional wager invention, are strictly voluntary and optional, as noted further above.

At this point, the dealer deals two cards face up to each player, and a single face up card for the dealer hand, as indicated in the second step 32 of FIG. 2A. (In some casinos and areas, one or more of these cards are dealt face down, with the players being unable to observe the dealer card. The present additional wagering provisions require the cards to be dealt face up. All cards must be visible to all participants, as both player and dealer cards must be considered in combination.)

Those players who have placed an additional supplemental wager in accordance with the present additional wagering provisions, are allowed to consider their two cards in combination with the single face up card of the dealer. This three card combination may be considered as a composite hand, as it uses the cards from both the player's hand and the dealer's hand. It should be noted that the cards are not physically relocated or combined together to form the composite hands of the present additional wagers, but are considered as a three card combination. It should also be noted that each player participating in the present additional wagering system uses his or her own two card pair as two of the cards of the composite hands, with each composite hand including the single face up dealer card common to all composite hands. Thus, all of the composite hands (one for each participating player) will have at least one single identical card therein, i.e., the single face up card of the dealer hand, and two other cards comprising the player hand for that individual player. All of these cards will be visible to all players and to the dealer during play of the hand.

The present additional wagering provisions provide for a series of sequential potential outcomes based upon the three card combinations of the composite hands of each of the participating players. The first potential outcome is that the three cards of the composite hand(s) have a total of twenty-one points, as indicated by the third step 34 of FIG. 2A. The point count is made in accordance with conventional blackjack rules, i.e., ten points for each face card (king, queen, jack) and other cards counting in accordance with their face value. Aces may count as one or eleven, as required to form the optimum count.

If the composite hand(s) of any participating player has a total of twenty-one points, then the player wins the first level of his or her additional wager, as indicated by the fourth step 36 in FIG. 2A. The payout may be provided by the casino or gambling house as desired, with a payout of ten to one, i.e., ten dollars back to the player for each dollar wagered on the additional composite hand wager, providing a reasonable payout to the player while still providing an “edge” to the house. The present inventor has calculated the odds of occurrence of the various composite hands in accordance with the present wagering provisions, with a table being provided further below. In the event that the player does not have a count of twenty-one in his or her composite hand, the player forfeits their supplemental wager and play of the blackjack hand continues conventionally, as indicated by the first step 38 of FIG. 2B, connecting to the third step 34 of FIG. 2A by the first connector 2B1.

In the event that a participating player has a composite hand having a count of twenty-one, in accordance with the third and fourth steps 34 and 36 of FIG. 2A, then additional winning possibilities exist. If the twenty-one count hand is formed of two ten count cards, i.e., any king, queen, or jack face card or a ten spot card, and an ace, as indicated in the fifth step 40 of FIG. 2A, then the participating player wins an additional payout from the house, as indicated by the sixth step 42 of FIG. 2A. It should be noted that the participating player need only place a single supplemental or additional wager in order to be eligible for the additional payout described immediately above, as well as the other potential payouts described further below. No further wagers need be made by the player in order for his or her composite hand to continue to be considered for additional payouts.

An alternative winning composite hand may be formed of a sequence comprising a six, a seven, and an eight spot card, with the six, seven, and eight having a total count of twenty-one points. As in the case of the two ten value cards and ace discussed further above, the six, seven, and eight may be distributed in any combination between the single dealer card and the two cards held by the participating player in his or her hand. In the event that a player holds a six-seven-eight sequence, as indicated in the seventh step 44 of FIG. 2A, the player will also win an additional payout, as indicated by the link of the seventh step 44 with the additional payout sixth step 42 of FIG. 2A.

The odds of a participating player receiving a sequence comprising a six, seven, and eight in his or her composite hand, are considerably lower than the odds of receiving two ten count cards and an ace. The payouts for these two specific twenty-one count hands are adjusted in accordance with the odds table provided further below. However, as both types of hands provide an additional payout, both of the steps. 40 and 44 extend to the same additional payout step 42 of FIG. 2A. If the twenty-one count hand comprises some other card combination, e.g., an ace and two fives, three spot cards comprising an eight, nine, and four, etc., then the standards indicated in the steps 40 and 44 in FIG. 2A are not met. In this event, no additional payout is provided to the participating player over and above the winning of the optional side bet step 36, with play of the blackjack game continuing conventionally, as indicated by the second step 46 of FIG. 2B, and connecting to the seventh step 44 of FIG. 2A by the 2B3 connector.

A further possibility exists that the three cards forming the composite hand will be flush, i.e., all of the same suit. If such a suited composite hand occurs, as indicated by the eighth step 48 of FIG. 2A, then the participating player wins yet another, or higher, payout, as indicated by the third step 50 of FIG. 2B, which connects to the eighth step 48 of FIG. 2A by means of the connector 2B2. If either of the hands described in steps 40 and 44 of FIG. 2A are not suited, then no further payout is provided over that already awarded and play continues conventionally, as indicated by step 46 of FIG. 2B, which connects to FIG. 2A by the connector 2B4.

In the event that a participating player holds two of the three cards forming a six-seven-eight sequence in his or her hand, particularly the two lowest cards of the series, he or she will likely wish to draw a third card in an attempt to have a higher hand than the dealer's, generally as indicated by the fourth step 52 of FIG. 2B. Again, the option for the player to draw a third card is independent of any optional wagers placed upon the composite hand, and is strictly a function of the player playing his or her blackjack hand; the two hands are independent of one another. However, the participating player may win an additional jackpot prize or award, in the event that a certain specific card is drawn or dealt for the participating player's third card.

If the participating player already has an identically suited sequential composite hand, i.e., a six, seven, and eight in his or her hand and in the dealer's hand, and draws a third card which precisely matches the dealer's face up card in both rank and suit, as indicated by the fifth step 54 of FIG. 2B, then that player wins an additional jackpot payout, as indicated by the sixth step 56 of FIG. 2B. (It will be seen that the chance of drawing an identically matching card in both rank and suit can only be provided where multiple decks of cards are used simultaneously, as is conventional in casino play.) If no third card is drawn, or if the third card drawn does not match the dealer's face up card in rank and suit, thenthe jackpot is not awarded and play continues conventionally, in accordance with step 46 of FIG. 2B.

The odds of the various events described above, and corresponding payouts, have been calculated by the present inventor. Table I, provided immediately below, lists these odds for the various events described above, and suggested payouts.

TABLE I
ODDS FOR WINNING COMPOSITE HANDS,
AND SUGGESTED PAYOUTS

| | APPROXIMATE | SUGGESTED |
|---|---|---|
| HAND | ODDS | PAYOUT |
| Unsuited Sum of 21 | 16:1 | 10:1 |
| Unsuited Two - Ten | 50:1 | 15:1 |
| Count Cards and Ace | | |
| Suited Sum of 21 | 250:1 | 30:1 |
| Unsuited 6 - 7 -8 | 385:1 | 50:1 |
| Suited Two - Ten | 750:1 | 100:1 |
| Count Cards and Ace | | |
| Suited 6 - 7 - 8 | 5800:1 | 250:1 |
| Jackpot (Drawing third | 360,000:1 | 25,000:1 |
| card in player's hand | | |
| which matches dealer's | | |
| up card in both rank and | | |
| suit) | | |

It will be noted that the above suggested payouts provide a significant “edge” to the house or casino, where the present additional wagering provisions are provided as an addition to a blackjack game played therein. This is important, as the house or casino must, of course, make a profit to stay in business. However, the edge provided by the difference between the above tabulated odds and payouts may be adjusted as desired by the casino or gambling establishment operating the game.

The notification to players that a portion of the income earned by the present game, e.g. licensing fees to the casino, will be contributed to one or more charitable causes, can provide an incentive for players to play, or perhaps for players already playing to place various optional or additional wagers in accordance with the present additional wagering provisions. Thus, the present additional wagering provisions provide additional opportunities for players to win, additional profits for the house or casino, and may also provide a source of income for a charitable cause. The result is greater enjoyment for the player, who has more options for wagering and potentially winning, the potential for greater profits for the house or casino due to the attraction of a greater number of players, and increased income for the selected charitable cause or causes.

It is to be understood that the present invention is not limited to the embodiments described above, but encompasses any and all embodiments within the scope of the following claims.

I claim:

1. A blackjack game apparatus, comprising:
a playing surface;
a single dealer position for a dealer, disposed upon said playing surface;
a plurality of player card placement areas for a corresponding number of players, disposed upon said playing surface;
a supplemental wagering position extending from each of said player card placement areas of said playing surface, with each said supplemental wagering position being positively and directly connected to a corresponding one of said player card placement areas; and
at least one fifty-two card deck of conventional playing cards, consisting of four suits, each of the suits having thirteen cards therein, each of said playing cards having a back surface and a face surface opposite said back surface, said face surface of each of said playing cards having suit and rank indicators thereon.

2. The blackjack game apparatus according to claim 1, further including at least one jackpot odds payout indicator disposed upon said playing surface.

3. The blackjack game apparatus according to claim 1, further including notification of donation to a charitable cause disposed upon said playing surface.

4. A method of providing additional wagers in the game of blackjack using the blackjack game apparatus of claim 1, comprising the steps of:
(a) placing an additional composite hand wager., by any of the players as desired;
(b) dealing two of the playing cards, face up, to each of the players;
(c) dealing one of the playing cards, face up, to the dealer;
(d) combining the two cards of each of the composite hand wagering players with the single face up card of the dealer, thereby forming a three card composite hand for each of the composite hand wagering players;
(e) providing a payout to any of the composite hand wagering players having a composite hand with a total count of twenty one; and
(f) continuing play of the blackjack game conventionally thereafter.

5. The method according to claim 4, further including the step of providing a payout to any of the composite hand wagering players having a composite hand consisting of two ten count cards and an ace.

6. The method according to claim 5, further including the step of providing a payout to any of the composite hand wagering players having a composite card hand consisting of two ten count cards and an ace, and all of the same suit.

7. The method according to claim 4, further including the step of providing a payout to any of the composite hand wagering players having a composite hand consisting of cards having counts of six, seven, and eight.

8. The method according to claim 7, further including the step of providing a payout to any of the composite hand wagering players having a composite hand consisting of cards having counts of six, seven, and eight, and all of the same suit.

9. The method according to claim 8, further including the steps of:
(a) providing at least two fifty-two card decks of conventional playing cards;
(b) drawing a third card, by any of the players; and
(c) providing a jackpot payout to any of the composite hand wagering players drawing a third player card which matches the count and suit of the single dealer card of the composite hand.

10. The method according to claim 4, further including the steps of:
(a) operating the game by an organized gambling house;
(b) providing notification of donation to a charitable cause upon the playing surface; and
(c) donating a portion of the income provided by the additional wagering provision to the charitable cause.

11. A method of providing additional wagers in the game of blackjack, comprising the steps of:
(a) providing a playing surface;
(b) placing a single dealer position for a dealer upon the playing surface;
(c) placing a plurality of player card placement areas for a corresponding number of players upon the playing surface;
(d) placing a supplemental wagering position adjacent each of said player card placement areas;
(e) positively and directly connecting each supplemental wagering position to a corresponding one of the player card placement areas;
(f) further providing at least one fifty-two card deck of conventional playing cards, consisting of four suits each having thirteen cards therein, each of the cards having a back surface and a face surface opposite the back surface, the face surface of each of the cards having suit and rank indicators thereon;
(g) placing an additional composite hand wager, by any of the players;
(h) dealing two of the playing cards, face up, to each of the players;
(i) dealing one of the playing cards, face up, to the dealer;
(j) combining the two cards of each of the composite hand wagering players with the single card of the dealer, thereby forming a three card composite hand for each of the composite hand wagering players;
(k) providing a payout to any of the composite hand wagering players having a composite hand with a total count of twenty-one; and
(l) continuing play of the blackjack game conventionally thereafter.

12. The method of providing additional wagers according to claim 11, further including the step of providing a payout to any of the composite hand wagering players having a composite hand consisting of two ten count cards and an ace.

13. The method of providing additional wagers according to claim 12, further including the step of providing a payout to any of the composite hand wagering players having a composite card hand consisting of two ten count cards and an ace, and all of the same suit.

14. The method of providing additional wagers according to claim 11, further including the step of providing a payout to any of the composite hand wagering players having a composite hand consisting of cards having counts of six, seven, and eight.

15. The method of providing additional wagers according to claim 14, further including the step of providing a payout to any of the composite hand wagering players having a composite hand consisting of cards having counts of six, seven, and eight, and all of the same suit.

16. The method of providing additional wagers according to claim 15, further including the steps of:
(a) drawing a third card, by any of the players; and
(b) providing a jackpot payout to any of the composite hand wagering players drawing a third card which matches the count and suit of the single dealer card of the composite hand.

17. The method of providing additional wagers according to claim 11, further including the steps of:
(a) operating the game by an organized gambling house;
(b) providing notification of donation to a charitable cause upon the playing surface; and
(c) donating a portion of the income provided by the additional wagering provision to the charitable cause.
